(19) United States
(12) Patent Application Publication
(10) Pub. No.: US 2021/0143535 A1
(43) Pub. Date: May 13, 2021

(54) ARRAY ANTENNA APPARATUS AND COMMUNICATION DEVICE

(71) Applicant: Mitsubishi Electric Corporation, Tokyo (JP)

(72) Inventors: Hikaru WATANABE, Tokyo (JP); Satoshi YAMAGUCHI, Tokyo (JP); Toru FUKASAWA, Tokyo (JP)

(73) Assignee: Mitsubishi Electric Corporation, Tokyo (JP)

(21) Appl. No.: 17/044,120

(22) PCT Filed: May 15, 2018
(86) PCT No.: PCT/JP2018/018760

§ 371 Date: Sep. 30, 2020

(51) Int. Cl. H01Q 1/38; H01Q 1/52; H01Q 21/06; H01Q 1/48

(52) U.S. Cl. CPC H01Q 1/38; H01Q 1/48; H01Q 21/065; H01Q 1/52

(57) ABSTRACT

An array antenna apparatus is configured to include a plurality of connecting conductors each provided inside a dielectric substrate in such a manner that one end of the connecting conductor is connected to a first ground conductor and another end of the connecting conductor is connected to a second ground conductor, a location of the one end connected to the first ground conductor being a location that surrounds any one of a plurality of radiation conductors.

### TECHNICAL FIELD

The invention relates to an array antenna apparatus having a plurality of radiation conductors formed on a dielectric substrate, and a communication device including the array antenna apparatus.

### BACKGROUND ART

The following Non-Patent Literature 1 discloses an array antenna having an array of patch antennas as radiation conductors.

In the array antenna having an array of patch antennas, the beam width of an array element pattern in an E-plane which is an electric field plane of the patch antennas is narrower than the beam width of an array element pattern in an H-plane which is a magnetic field plane.

Therefore, when the array antenna whose main beam direction is an E-plane direction performs wide-angle beam scanning, a beam scanning loss may increase.

It is conceivable that one of the factors of increasing the beam scanning loss is that since the influence of surface waves is great in the E-plane direction of the array antenna, cross-coupling between the plurality of patch antennas increases.

The following Non-Patent Literature 1 describes that surface waves can be suppressed when a thickness h of a substrate having patch antennas formed on its one surface and having a ground plate formed on its other surface is a thickness satisfying the following expression (1):

$$h \leq \frac{0.3 {λ}_{0}}{2 π \sqrt{{ϵ}_{r}}} \qquad ( 1 )$$

In expression (1), λ₀ is free-space wavelength and εᵣ is the dielectric constant of the substrate.

### CITATION LIST

### Non-Patent Literature

Non-Patent Literature 1: Ramesh Garg, Prakash Bhartia, Inder Bahl, “Microstrip Antenna Design Handbook”, Artech House Antennas and Propagation Library, p. 46, 2000

### SUMMARY OF INVENTION

### Technical Problem

The conventional array antenna can suppress surface waves when the thickness h of the substrate satisfies expression (1). However, the thickness h of the substrate also influences the frequency band of the antenna, and when the thickness h of the substrate is thin, the frequency band of the antenna is narrow.

To ensure a desired frequency band, the conventional array antenna may not be able to ensure a thickness that satisfies expression (1) as the thickness h of the substrate.

When the conventional array antenna cannot ensure a thickness that satisfies expression (1) as the thickness h of the substrate, there is a problem that surface waves cannot be suppressed.

The invention is made to solve a problem such as that described above, and an object of the invention is to obtain an array antenna apparatus and a communication device that can suppress surface waves while ensuring a desired frequency band.

### Solution to Problem

An array antenna apparatus according to the invention includes: a dielectric substrate; a plurality of radiation conductors formed on a first plane of the dielectric substrate; a first ground conductor formed on portions of the first plane of the dielectric substrate at locations that surround the plurality of radiation conductors and that create clearances between the plurality of radiation conductors; a second ground conductor formed on a portion of a second plane of the dielectric substrate at a location opposite to the first ground conductor; a plurality of connecting conductors each provided inside the dielectric substrate in such a manner that one end of the connecting conductor is connected to the first ground conductor and another end of the connecting conductor is connected to the second ground conductor, a location of the one end connected to the first ground conductor being a location that surrounds any one of the plurality of radiation conductors; a dielectric layer having one surface bonded to the second plane of the dielectric substrate and the second ground conductor; and a feeding substrate having one surface bonded to another surface of the dielectric layer, the feeding substrate electromagnetically coupling radio waves to the plurality of radiation conductors through the dielectric layer and the dielectric substrate.

### Advantageous Effects of Invention

According to the invention, an array antenna apparatus is configured to include a plurality of connecting conductors each provided inside a dielectric substrate in such a manner that one end of the connecting conductor is connected to a first ground conductor and another end of the connecting conductor is connected to a second ground conductor, a location of the one end connected to the first ground conductor being a location that surrounds any one of a plurality of radiation conductors. Therefore, the array antenna apparatus according to the invention can suppress surface waves while ensuring a desired frequency band.

### BRIEF DESCRIPTION OF DRAWINGS

FIG. 1 is a plan view showing an array antenna apparatus of a first embodiment.

FIG. 2 is a B-B′ cross-sectional view of the array antenna apparatus shown in FIG. 1.

FIG. 3 is a cross-sectional view showing the inside of a feeding substrate 8 of the array antenna apparatus shown in FIG. 2.

FIG. 4 is a plan view showing a simulation-target array antenna apparatus.

FIG. 5 is an explanatory diagram showing simulation results for a radiation pattern in an E-plane direction of the array antenna apparatus shown in FIG. 4.

FIG. 6 is a cross-sectional view showing an array antenna apparatus of a second embodiment.

FIG. 7 is an explanatory diagram showing simulation results for array element patterns of array antenna apparatuses.

FIG. 8 is an explanatory diagram showing reflectance properties of the array antenna apparatuses.

FIG. 9 is a cross-sectional view showing an array antenna apparatus of a third embodiment.

FIG. 10 is an explanatory diagram showing an arrangement of a plurality of radiation conductors 2 on a first plane 1a of a dielectric substrate 1.

FIG. 11 is an explanatory diagram showing an arrangement of the plurality of radiation conductors 2 on the first plane 1a of the dielectric substrate 1.

FIG. 12 is an explanatory diagram showing an arrangement of the plurality of radiation conductors 2 on the first plane 1a of the dielectric substrate 1.

FIG. 13 is a configuration diagram showing a communication device of a sixth embodiment.

### DESCRIPTION OF EMBODIMENTS

To describe the invention in more detail, embodiments for carrying out the invention will be described below with reference to the accompanying drawings.

### First Embodiment

FIG. 1 is a plan view showing an array antenna apparatus of a first embodiment.

FIG. 2 is a B-B′ cross-sectional view of the array antenna apparatus shown in FIG. 1.

In FIGS. 1 and 2, a dielectric substrate 1 is a substrate formed of a dielectric.

Radiation conductors 2 each are a square patch element formed on a first plane 1a of the dielectric substrate 1.

In the array antenna apparatus shown in FIG. 1, nine radiation conductors 2 (three radiation conductors 2 in an X-direction and three radiation conductors 2 in a Y-direction) are formed on the first plane 1a of the dielectric substrate 1. However, it is sufficient that a plurality of radiation conductors 2 are formed on the first plane 1a, and two to eight radiation conductors 2 or ten or more radiation conductors 2 may be formed.

In the array antenna apparatus shown in FIG. 1, the radiation conductors 2 have a square shape. However, the radiation conductors 2 may have any shape and may have a triangle shape, a pentagon shape, a circle shape, or the like.

A first ground conductor 3 is a conductor grid formed on portions of the first plane 1a of the dielectric substrate 1 at locations that surround the plurality of radiation conductors 2 and that create clearances 4 between the plurality of radiation conductors 2.

In the array antenna apparatus shown in FIG. 1, since the nine radiation conductors 2 have a square shape, the first ground conductor 3 has a shape in which nine squares are cut out.

A second ground conductor 5 is a conductor grid formed on a portion of a second plane 1b of the dielectric substrate 1 at a location opposite to the first ground conductor 3.

The first ground conductor 3 and the second ground conductor 5 have the same shape.

Connecting conductors 6 each are a through-hole via provided inside the dielectric substrate 1 in such a manner that one end thereof is connected to the first ground conductor 3 and the other end thereof is connected to the second ground conductor 5.

A location of the one end of the connecting conductor 6 connected to the first ground conductor 3 is a location that surrounds any one of the plurality of radiation conductors 2.

In the array antenna apparatus shown in FIG. 1, 24 connecting conductors 6 are connected at their one ends to the first ground conductor 3 per radiation conductor 2 so as to surround the radiation conductor 2.

A dielectric layer 7 is a layer having one surface 7a bonded to the second plane 1b of the dielectric substrate 1 and the second ground conductor 5.

The dielectric layer 7 is a layer formed of a dielectric having the same dielectric constant as that of the dielectric that forms the dielectric substrate 1.

The dielectric layer 7 is not limited to a layer formed of a dielectric and may be, for example, a layer formed of a dielectric adhesive having the same dielectric constant as that of the dielectric that forms the dielectric substrate 1.

A feeding substrate 8 is a substrate that has one surface 8a bonded to another surface 7b of the dielectric layer 7 and that electromagnetically couples radio waves to the plurality of radiation conductors 2 through the dielectric layer 7 and the dielectric substrate 1.

The feeding substrate 8 includes a triplate line as a line for electromagnetically coupling radio waves to the respective plurality of radiation conductors 2.

An element occupation area 9 is an occupation area per radiation conductor 2, and is determined by spacing in the X-direction between the radiation conductors 2 and spacing in the Y-direction between the radiation conductors 2.

Locations at which one ends of the plurality of connecting conductors 6 surround the radiation conductor 2 are inside the element occupation area 9.

FIG. 3 is a cross-sectional view showing the inside of the feeding substrate 8 of the array antenna apparatus shown in FIG. 2.

In FIG. 3, a ground conductor 11 is formed on the one surface 8a of the feeding substrate 8.

A ground conductor 12 is formed on another surface 8b of the feeding substrate 8.

A central conductor 13 is a conductor formed between the ground conductor 11 and the ground conductor 12.

Connecting conductors 14 each are provided inside the feeding substrate 8 in such a manner that one end thereof is connected to the ground conductor 11 and the other end thereof is connected to the ground conductor 12.

Connecting conductors 15 each have one end connected to the central conductor 13 and the other end coming out of the feeding substrate 8.

Coupling slots 16 each are an opening made in the ground conductor 11 to electromagnetically couple a corresponding one of the plurality of radiation conductors 2 to a radio wave.

Each of the ground conductor 11, the ground conductor 12, the central conductor 13, the connecting conductors 14, the connecting conductors 15, and the coupling slots 16 is an element of the triplate line included in the feeding substrate 8.

Next, the operation will be described.

In the feeding substrate 8, since the coupling slots 16 are made in the ground conductor 11, when electrical signals are fed to the connecting conductors 15 from an external source, radio waves are electromagnetically coupled to the plurality of radiation conductors 2 through the dielectric layer 7 and the dielectric substrate 1.

The radio waves coupled to the plurality of radiation conductors 2 are radiated into space.

Note, however, that a part of the radio waves coupled to the plurality of radiation conductors 2 becomes surface-wave components that propagate through the dielectric substrate 1.

When the plurality of connecting conductors 6 are not arranged so as to surround the radiation conductors 2, a surface-wave component which is a part of a radio wave coupled to a given radiation conductor 2 propagates to another radiation conductor 2 adjacent to the given radiation conductor 2.

By the surface-wave component propagating to another radiation conductor 2, cross-coupling between the plurality of radiation conductors 2 increases, increasing a beam scanning loss of the array antenna apparatus.

In the array antenna apparatus shown in FIG. 1, since the plurality of connecting conductors 6 are arranged so as to surround the radiation conductors 2, a surface-wave component from a radiation conductor 2 surrounded by the plurality of connecting conductors 6 is shielded by the plurality of connecting conductors 6, the first ground conductor 3, and the second ground conductor 5.

Therefore, the array antenna apparatus shown in FIG. 1 suppresses an increase in cross-coupling between the plurality of radiation conductors 2, and thus can suppress a reduction in gain in a wide-angle direction of an array element pattern.

In addition, in the array antenna apparatus shown in FIG. 1, since surface-wave components from the radiation conductors 2 are shielded by the plurality of connecting conductors 6, the first ground conductor 3, and the second ground conductor 5, a thickness h of the dielectric substrate 1 does not need to be a thickness satisfying expression (1). Namely, in the array antenna apparatus shown in FIG. 1, even if the thickness h of the dielectric substrate 1 is thicker than (0.3λ₀)/(2π√εᵣ), surface-wave components from the radiation conductors 2 can be shielded.

Hence, in the array antenna apparatus shown in FIG. 1, since the thickness h of the dielectric substrate 1 can be made thicker than (0.3λ₀)/(2π√εᵣ), the frequency band of the antenna can be widened.

When an array antenna apparatus does not include the plurality of connecting conductors 6, the first ground conductor 3, and the second ground conductor 5, a radiation region of a main radiation component, which is a radio wave radiated into space, per radiation conductor 2 corresponds to a region of the element occupation area 9 excluding the radiation conductor 2.

The array antenna apparatus shown in FIG. 1 includes the plurality of connecting conductors 6, the first ground conductor 3, and the second ground conductor 5, and thus, a radiation region of a main radiation component per radiation conductor 2 corresponds to a portion of a region surrounded by the plurality of connecting conductors 6 excluding the radiation conductor 2.

Therefore, the array antenna apparatus shown in FIG. 1 has a smaller radiation region of a main radiation component than that of the array antenna apparatus that does not include the plurality of connecting conductors 6, the first ground conductor 3, and the second ground conductor 5, and thus can widen the beam width of an array element pattern.

Here, there is an array antenna apparatus with a cavity structure that includes a dielectric substrate having a plurality of radiation conductors formed on a first plane and having a ground plate formed on a second plane; and a feeding substrate grounded to the ground plate.

In the array antenna apparatus with a cavity structure, upon multi-layering the dielectric substrate and the feeding substrate, the dielectric substrate and the feeding substrate are often fixed by screwing. When the dielectric substrate and the feeding substrate are fixed by screwing, a misalignment, etc., may occur between the dielectric substrate and the feeding substrate, by which electrical characteristics of the antenna may change from designed values.

The array antenna apparatus shown in FIG. 1 has a structure in which the feeding substrate 8 is bonded to the dielectric substrate 1 through the dielectric layer 7 therebetween, and the feeding substrate 8 does not need to be grounded to the second ground conductor 5.

Therefore, in the structure of the array antenna apparatus shown in FIG. 1, it is sufficient multi-layering the dielectric substrate 1 and the feeding substrate 8 through the dielectric layer 7 therebetween, and compared to the cavity structure, multi-layering of the dielectric substrate 1 and the feeding substrate 8 is easy. Thus, a misalignment, etc., are less likely to occur between the dielectric substrate 1 and the feeding substrate 8, reducing the possibility that electrical characteristics of the antenna change from designed values.

The fact that the array antenna apparatus of the first embodiment can achieve wide coverage by widening the beam width of an array element pattern will be described below.

FIG. 4 is a plan view showing a simulation-target array antenna apparatus, and in FIG. 4, the same reference signs as those in FIG. 1 indicate the same or corresponding portions.

In the array antenna apparatus shown in FIG. 4, 32 radiation conductors 2 (eight radiation conductors 2 in the X-direction and four radiation conductors 2 in the Y-direction) are formed on the first plane 1a of the dielectric substrate 1.

FIG. 5 is an explanatory diagram showing simulation results for a radiation pattern (array element pattern) in an E-plane direction of the array antenna apparatus shown in FIG. 4.

FIG. 5 also shows simulation results for an array element pattern of a comparison-target array antenna apparatus, in addition to the array antenna apparatus shown in FIG. 4 which is the array antenna apparatus of the first embodiment.

In the comparison-target array antenna apparatus, too, 32 radiation conductors 2 (eight radiation conductors 2 in the X-direction and four radiation conductors 2 in the Y-direction) are formed on the first plane 1a of the dielectric substrate 1, but the comparison-target array antenna apparatus does not include the connecting conductors 6, the first ground conductor 3, and the second ground conductor 5.

In simulation, any one of the 32 radiation conductors 2 is selected in turn, and an array element pattern at a time when each of the selected radiation conductors 2 is excited is computed. Then, in the simulation, an average value of the computed 32 array element patterns is calculated.

In the simulation, upon exciting any one of the radiation conductors 2, the other 31 radiation conductors 2 are matched and terminated.

In addition, in the simulation, the spacing between the 32 radiation conductors 2 is 0.54 free-space wavelength.

In FIG. 5, a horizontal axis represents angle and a vertical axis represents gain normalized with gain in a 0-degree front direction.

Reference sign 21 indicates simulation results for an array element pattern of the array antenna apparatus shown in FIG. 4, and reference sign 22 indicates simulation results for an array element pattern of the comparison-target array antenna apparatus.

When the beam width of an array element pattern is −60 to +60 degrees, the beam width of the array element pattern is generally said to be wide.

In addition, when the gain of an array element pattern is roughly greater than −3 dB, the gain is generally said to be large.

When the simulation results 21 are compared with the simulation results 22, at a beam width of −60 to +60 degrees, the gain of the array element pattern indicated by the simulation results 21 is larger than the gain of the array element pattern indicated by the simulation results 22.

In addition, in the simulation results 21, the gain of the array element pattern is roughly greater than −3 dB at a beam width of −60 to +60 degrees.

Therefore, it can be seen that compared to the comparison-target array antenna apparatus, in the array antenna apparatus shown in FIG. 4, the beam width of the array element pattern is widened, and wide coverage can be achieved.

In the above-described first embodiment, an array antenna apparatus is configured to include the plurality of connecting conductors 6 each provided inside the dielectric substrate 1 in such a manner that one end thereof is connected to the first ground conductor 3 and the other end thereof is connected to the second ground conductor 5, and a location of the one end connected to the first ground conductor 3 being a location that surrounds any one of the plurality of radiation conductors 2. Therefore, the array antenna apparatus can suppress surface waves while ensuring a desired frequency band.

The feeding substrate 8 shown in FIG. 3 includes the triplate line for electromagnetically coupling radio waves to the respective plurality of radiation conductors 2. However, a line for electromagnetically coupling radio waves is not limited to the triplate line.

Therefore, the feeding substrate 8 may have, for example, a ground conductor formed on the other surface 8b and a microstrip line formed on the one surface 8a, as a line for electromagnetically coupling radio waves to the respective plurality of radiation conductors 2.

### Second Embodiment

The array antenna apparatus of the first embodiment shows an array antenna apparatus in which the dielectric substrate 1 is a single-layer substrate.

A second embodiment describes an array antenna apparatus in which the dielectric substrate 1 is a multi-layer substrate having a plurality of dielectric substrates stacked on top of each other.

FIG. 6 is a cross-sectional view showing an array antenna apparatus of the second embodiment.

A plan view of the array antenna apparatus of the second embodiment is the same as that of FIG. 1, and FIG. 6 shows a B-B′ cross section of the array antenna apparatus shown in FIG. 1.

In FIG. 6, the same reference signs as those in FIGS. 1 to 3 indicate the same or corresponding portions and thus description thereof is omitted.

A dielectric substrate 1 is a multi-layer substrate including a dielectric substrate 31, a dielectric layer 32, and a dielectric substrate 33.

The dielectric substrate 31, the dielectric layer 32, and the dielectric substrate 33 have the same dielectric constant.

The dielectric layer 32 is a layer inserted between the dielectric substrate 31 and the dielectric substrate 33, and is formed of a dielectric.

Note, however, that the dielectric layer 32 is not limited to a layer formed of a dielectric and may be, for example, a layer formed of a dielectric adhesive.

The array antenna apparatus shown in FIG. 6 shows an array antenna apparatus in which the dielectric substrate 1 is a multi-layer substrate having three layers. However, the dielectric substrate 1 is not limited to a multi-layer substrate having three layers, and may be a multi-layer substrate having two layers or four or more layers.

When the dielectric substrate 1 is a single-layer substrate, the thickness of the dielectric substrate 1 has an upper limit and the dielectric substrate 1 may not be able to ensure a desired thickness.

In the array antenna apparatus shown in FIG. 6, since the dielectric substrate 1 is a multi-layer substrate, by increasing the number of stacked layers of the multi-layer substrate, the thickness of the dielectric substrate 1 can be made thicker than the thickness of a single-layer substrate.

Therefore, by increasing the thickness of the dielectric substrate 1, the array antenna apparatus shown in FIG. 6 can further widen the frequency band than the array antenna apparatus of the first embodiment.

FIG. 7 is an explanatory diagram showing simulation results for array element patterns of array antenna apparatuses.

FIG. 7 shows simulation results for an array element pattern obtained when the dielectric substrate 1 is a single-layer substrate, and simulation results for an array element pattern obtained when the dielectric substrate 1 is a multi-layer substrate.

An array antenna apparatus with the dielectric substrate 1 being a single-layer substrate is the array antenna apparatus of the first embodiment, and an array antenna apparatus with the dielectric substrate 1 being a multi-layer substrate is the array antenna apparatus of the second embodiment.

It is assumed that in both array antenna apparatuses, as shown in FIG. 4, 32 radiation conductors 2 are formed.

In simulation, any one of the 32 radiation conductors 2 is selected in turn, and an array element pattern at a time when each of the selected radiation conductors 2 is excited is computed. Then, in the simulation, an average value of the computed 32 array element patterns is calculated.

In the simulation, it is assumed that, upon exciting any one of the radiation conductors 2, the other 31 radiation conductors 2 are matched and terminated.

In addition, in the simulation, the spacing between the 32 radiation conductors 2 is 0.54 free-space wavelength.

In FIG. 7, a horizontal axis represents angle and a vertical axis represents gain normalized with gain in a 0-degree front direction.

Reference sign 23 indicates simulation results for an array element pattern obtained when the dielectric substrate 1 is a single-layer substrate, and reference sign 24 indicates simulation results for an array element pattern obtained when the dielectric substrate 1 is a multi-layer substrate.

The simulation results 23 and the simulation results 24 are substantially the same.

Therefore, it can be seen that in the array antenna apparatus whose dielectric substrate 1 is a multi-layer substrate, too, the beam width of the array element pattern is further widened and wider coverage can be achieved over the comparison-target array antenna apparatus shown in the first embodiment.

FIG. 8 is an explanatory diagram showing reflectance properties of the array antenna apparatuses.

In FIG. 8, a horizontal axis represents frequency normalized with a center frequency f₀ of a frequency band, and a vertical axis represents the reflection coefficient of the antenna. Reflection coefficients shown in FIG. 8 are also obtained by simulation.

Reference sign 25 indicates the reflection coefficient of the antenna obtained when the dielectric substrate 1 is a single-layer substrate, and reference sign 26 indicates the reflection coefficient of the antenna obtained when the dielectric substrate 1 is a multi-layer substrate.

As is clear by comparing the reflection coefficient 25 with the reflection coefficient 26, it can be seen that the array antenna apparatus whose dielectric substrate 1 is a multi-layer substrate obtains a lower reflection characteristic over the low to high frequency sides of the frequency band than that of the array antenna apparatus whose dielectric substrate 1 is a single-layer substrate.

In the above-described second embodiment, the array antenna apparatus is configured in such a manner that the dielectric substrate 1 is a multi-layer substrate having a plurality of dielectric substrates stacked on top of each other. Therefore, the array antenna apparatus can obtain a lower reflection characteristic over a wide frequency band than an array antenna apparatus whose dielectric substrate 1 is a single-layer substrate.

### Third Embodiment

In the array antenna apparatus of the first embodiment, the radiation conductors 2 are formed on the first plane 1a of the dielectric substrate 1.

A third embodiment describes an array antenna apparatus in which second radiation conductors 30 are also formed in the middle of a dielectric substrate 1 which is a multi-layer substrate, in addition to the radiation conductors 2 formed on the first plane 1a of the dielectric substrate 1.

FIG. 9 is a cross-sectional view showing the array antenna apparatus of the third embodiment.

A plan view of the array antenna apparatus of the third embodiment is the same as that of FIG. 1, and FIG. 9 shows a B-B′ cross section of the array antenna apparatus shown in FIG. 1.

In FIG. 9, the same reference signs as those in FIGS. 1 to 3 and 6 indicate the same or corresponding portions and thus description thereof is omitted.

The radiation conductors 2 shown in FIG. 9 are first radiation conductors.

The plurality of second radiation conductors 30 are formed at locations on the dielectric substrate 33 included in the dielectric substrate 1 that are opposite to the respective plurality of first radiation conductors 2.

In the array antenna apparatus shown in FIG. 9, the second radiation conductors 30 are formed on the dielectric substrate 33. However, the second radiation conductors 30 are not limited to being formed on the dielectric substrate 33. Therefore, the second radiation conductors 30 may be formed on, for example, a plane of the dielectric substrate 31 on a dielectric layer 32 side.

In the array antenna apparatus shown in FIG. 9, the first radiation conductors 2 and the second radiation conductors 30 are stacked on top of each other.

For example, when the second radiation conductors 30 different in thickness than the first radiation conductors 2 are formed on the dielectric substrate 33, the array antenna apparatus shown in FIG. 9 causes multiple resonance in which the resonant frequency of the first radiation conductors 2 and the resonant frequency of the second radiation conductors 30 differ from each other.

An array antenna apparatus that causes multiple resonance does not have the second radiation conductors 30 formed therein, and thus can achieve wide coverage compared to an array antenna apparatus that does not cause multiple resonance.

Here, the second radiation conductors 30 different in thickness than the first radiation conductors 2 are formed on the dielectric substrate 33. An array antenna apparatus in which the second radiation conductors 30 different in shape than the first radiation conductors 2 are formed on the dielectric substrate 33 also causes multiple resonance.

### Fourth Embodiment

A fourth embodiment describes an array antenna apparatus in which a thickness h₇ of the dielectric layer 7 is a thickness satisfying the following expression (2):

$${h}_{7} \leq \frac{0.3 {λ}_{0}}{2 π \sqrt{{ϵ}_{r}}} \qquad ( 2 )$$

In expression (2), λ₀ is free-space wavelength and εᵣ is the dielectric constant of the dielectric layer 7.

A cross-sectional view of the array antenna apparatus of the fourth embodiment is any one of FIGS. 2, 3, 6, and 9.

In the array antenna apparatus of the fourth embodiment, surface-wave components from the radiation conductors 2 are shielded by the plurality of connecting conductors 6, the first ground conductor 3, and the second ground conductor 5.

The array antenna apparatus of the fourth embodiment further suppresses surface-wave components from the radiation conductors 2 by setting the thickness h₇ of the dielectric layer 7 to be a thickness satisfying expression (2).

When the thickness h₇ of the dielectric layer 7 is a thickness satisfying expression (2), since the thickness h₇ of the dielectric layer 7 is sufficiently thin, a propagation path of a surface-wave component between adjacent radiation conductors 2 can be considered to be electrically substantially shielded.

Therefore, the influence of cross-coupling between the adjacent radiation conductors 2 can be further reduced.

In the above-described fourth embodiment, an array antenna apparatus is configured in such a manner that the thickness h₇ of the dielectric layer 7 is a thickness satisfying expression (2). Therefore, the array antenna apparatus further suppresses surface waves and can widen an array element pattern over the array antenna apparatus of the first embodiment.

### Fifth Embodiment

In the array antenna apparatus of the first embodiment, an arrangement of the plurality of radiation conductors 2 on the first plane 1a of the dielectric substrate 1 is a square arrangement.

However, this is merely an example and the array antenna apparatus may be configured in such a manner that, as shown in FIG. 10, an arrangement of the plurality of radiation conductors 2 on the first plane 1a of the dielectric substrate 1 is a linear arrangement, and can obtain the same advantageous effect as that of the array antenna apparatus of the first embodiment.

In addition, the array antenna apparatus may be configured in such a manner that, as shown in FIG. 11, an arrangement of the plurality of radiation conductors 2 on the first plane 1a of the dielectric substrate 1 is a triangular arrangement, and can obtain the same advantageous effect as that of the array antenna apparatus of the first embodiment.

In addition, the array antenna apparatus may be configured in such a manner that, as shown in FIG. 12, an arrangement of the plurality of radiation conductors 2 on the first plane 1a of the dielectric substrate 1 is a non-periodic arrangement, and can obtain the same advantageous effect as that of the array antenna apparatus of the first embodiment.

FIGS. 10 to 12 are explanatory diagrams showing arrangements of the plurality of radiation conductors 2 on the first plane 1a of the dielectric substrate 1.

### Sixth Embodiment

A sixth embodiment describes a communication device having any one of the array antenna apparatuses of the first to fifth embodiments mounted thereon.

FIG. 13 is a configuration diagram showing a communication device of the sixth embodiment.

In FIG. 13, an array antenna apparatus 41 is an array antenna apparatus that transmits and receives radio waves, and is any one of the array antenna apparatuses of the first to fifth embodiments.

A communication unit 42 is connected to the connecting conductors 15 of the array antenna apparatus 41.

The communication unit 42 outputs, as an electrical signal corresponding to a transmission-target radio wave, for example, an electrical signal which is modulated by a modulator installed therein to the connecting conductors 15 of the array antenna apparatus 41.

In addition, the communication unit 42 collects electrical signals corresponding to radio waves received by the array antenna apparatus 41, from the connecting conductors 15 of the array antenna apparatus 41.

The communication device may be a mobile communication device or a fixed communication device.

The communication device can perform wireless communication with other communication devices by mounting the array antenna apparatus 41 and the communication unit 42 thereon.

The sixth embodiment shows the communication device including the array antenna apparatus 41. However, it is not limited thereto, and a radar apparatus including the array antenna apparatus 41 may be adopted.

Note that in the invention of this application, a free combination of the embodiments, modifications to any component of the embodiments, or omissions of any component in the embodiments are possible within the scope of the invention.

### INDUSTRIAL APPLICABILITY

The invention is suitable for an array antenna apparatus having a plurality of radiation conductors formed on a dielectric substrate.

The invention is suitable for a communication device including the array antenna apparatus.

### REFERENCE SIGNS LIST

1: dielectric substrate, 1a: first plane, 1b: second plane, 2: radiation conductor (first radiation conductor), 3: first ground conductor, 4: clearance, 5: second ground conductor, 6: connecting conductor, 7: dielectric layer, 7a: one surface, 7b: other surface, 8: feeding substrate, 8a: one surface, 8b: other surface, 9: element occupation area, 11, 12: ground conductor, 13: central conductor, 14, 15: connecting conductor, 16: coupling slot, 21 to 24: simulation results, 25, 26: reflection coefficient, 30: second radiation conductor, 31: dielectric substrate, 32: dielectric layer, 33: dielectric substrate 33, 41: array antenna apparatus, 42: communication unit

1. An array antenna apparatus comprising:
a dielectric substrate;
a plurality of radiation conductors formed on a first plane of the dielectric substrate;
a first ground conductor formed on portions of the first plane of the dielectric substrate at locations that surround the plurality of radiation conductors and that create clearances between the plurality of radiation conductors;
a second ground conductor formed on a portion of a second plane of the dielectric substrate at a location opposite to the first ground conductor;
a plurality of connecting conductors each provided inside the dielectric substrate in such a manner that one end of the connecting conductor is connected to the first ground conductor and another end of the connecting conductor is connected to the second ground conductor, a location of the one end connected to the first ground conductor being a location that surrounds any one of the plurality of radiation conductors;
a dielectric layer having one surface bonded to the second plane of the dielectric substrate and the second ground conductor; and
a feeding substrate having one surface bonded to another surface of the dielectric layer, the feeding substrate electromagnetically coupling radio waves to the plurality of radiation conductors through the dielectric layer and the dielectric substrate.

2. The array antenna apparatus according to claim 1, wherein the dielectric substrate is a multi-layer substrate having a plurality of dielectric substrates stacked on top of each other.

3. The array antenna apparatus according to claim 2, wherein
each of the plurality of radiation conductors formed on the first plane is a first radiation conductor, and
second radiation conductors are formed one by one at locations between the plurality of dielectric substrates included in the multi-layer substrate, the locations opposite to the respective plurality of first radiation conductors.

4. The array antenna apparatus according to claim 1, wherein when a layer thickness of the dielectric layer is h, free-space wavelength is λ₀, and a dielectric constant of the dielectric layer is εᵣ, a following inequality holds true for the layer thickness h.
$$h \leq \frac{0.3 {λ}_{0}}{2 π \sqrt{{ϵ}_{r}}} \qquad [ Inequality ]$$

5. The array antenna apparatus according to claim 1, wherein an arrangement of the plurality of radiation conductors on the first plane of the dielectric substrate is a square arrangement.

6. The array antenna apparatus according to claim 1, wherein an arrangement of the plurality of radiation conductors on the first plane of the dielectric substrate is a triangular arrangement.

7. The array antenna apparatus according to claim 1, wherein an arrangement of the plurality of radiation conductors on the first plane of the dielectric substrate is a non-periodic arrangement.

8. The array antenna apparatus according to claim 1, wherein the feeding substrate includes a line for electromagnetically coupling radio waves to the respective plurality of radiation conductors.

9. A communication device comprising:
an array antenna apparatus to transmit and receive radio waves; and
a communicator to output an electrical signal corresponding to a transmission-target radio wave to the array antenna apparatus, and collect electrical signals corresponding to radio waves received by the array antenna apparatus, wherein
the array antenna apparatus includes:
a dielectric substrate;
a plurality of radiation conductors formed on a first plane of the dielectric substrate;
a first ground conductor formed on portions of the first plane of the dielectric substrate at locations that surround the plurality of radiation conductors and that create clearances between the plurality of radiation conductors;
a second ground conductor formed on a portion of a second plane of the dielectric substrate at a location opposite to the first ground conductor;
a plurality of connecting conductors each provided inside the dielectric substrate in such a manner that one end of the connecting conductor is connected to the first ground conductor and another end of the connecting conductor is connected to the second ground conductor, a location of the one end connected to the first ground conductor being a location that surrounds any one of the plurality of radiation conductors;
a dielectric layer having one surface bonded to the second plane of the dielectric substrate and the second ground conductor; and
a feeding substrate having one surface bonded to another surface of the dielectric layer, the feeding substrate electromagnetically coupling radio waves to the plurality of radiation conductors through the dielectric layer and the dielectric substrate.
